(19) United States
(12) Patent Application Publication
(10) Pub. No.: US 2017/0272164 A1
(43) Pub. Date: Sep. 21, 2017

(54) PULSE AMPLITUDE MODULATION (PAM) OVER MULTI-MODE LINK WITH RECEIVER SPATIAL FILTERING

(71) Applicant: Cisco Technology, Inc., San Jose, CA (US)

(72) Inventors: Marco MAZZINI, San Jose, CA (US); Matthew Joseph TRAVERSO, Santa Clara, CA (US); Mark NOWELL, San Jose, CA (US)

(21) Appl. No.: 15/075,669

(22) Filed: Mar. 21, 2016

(51) Int. Cl. H04B 10/2581; H04B 10/564; H04B 10/54; H04B 10/079; H04B 10/524; H04B 10/516; H04B 10/66

(52) U.S. Cl. CPC H04B 10/2581; H04B 10/5161; H04B 10/564; H04B 10/66; H04B 10/07955; H04B 10/524; H04B 10/541

(57) ABSTRACT

Aspects of the present disclosure provide techniques for spatial filtering of multilevel Pulse Amplitude Modulated (PAM) optical signals. An example method is provided for operations which may be performed by components of an optical network, including but not limited to an optical transceiver. The example method generally includes receiving an optical signal that is pulse amplitude modulated (PAM) to encode information of a network packet as a series of optical signal pulses transmitted via an optical fiber, performing spatial filtering, at a transition from the optical fiber to a receiver, on the optical signal, and performing demodulation of the spatially filtered optical signal to decode the information of the network packet.

### TECHNICAL FIELD

The present disclosure generally relates to transmission and reception of pulse amplitude modulation (PAM) signals over optical fiber.

### BACKGROUND

Many high-speed transmission networks rely on optical communication devices for facilitating transmission of data over various distances through optical fiber links. Higher reliability and data rates, along with lower power utilization of fiber relative to conventional copper wire infrastructure, have contributed to an increased demand for fiber communication networks. Particularly, physical links of conventional copper interconnections between chip-to-chip communications and server-to-server communications have been replaced by physical links of optical fibers mostly because significantly greater bandwidth of the fibers than conventional copper.

An optical fiber can guide light waves in distinct patterns called modes. A mode describes a distribution of light energy across a fiber. The precise patterns depend on wavelengths of a transmitted light and on variations in refractive index that shapes a fiber core. When a light (optical) signal travels through an optic fiber, the light can travel in one or more modes of transmission. When there is one mode (fundamental mode) for light waves to travel through a fiber, the fiber is referred to as a single-mode fiber (SMF). When there are more than one mode for light waves to travel through a fiber (fundamental mode plus higher-order modes), the fiber is referred to as a multi-mode fiber (MMF). A receiving front-end that is compatible with both single-mode and multi-mode applications present challenges, including physical incompatibility due to differences in core diameters, and incompatibility of parameter setting requirements for sufficient signal propagation.

### BRIEF DESCRIPTION OF THE DRAWINGS

FIGS. 1A-1B illustrate block diagrams conceptually illustrating examples of an optical network, in accordance with certain aspects of the present disclosure.

FIG. 2 illustrates an example of structural optical components for spatial filtering of PAM optical signaling, in accordance with certain aspects of the preset disclosure.

FIG. 3 illustrates another example of structural optical components for spatial filtering of PAM optical signaling, in accordance with certain aspects of the present disclosure.

FIG. 4 illustrates example operations that may be performed for spatial filtering of optical PAM signal, in accordance with certain aspects of the present disclosure.

FIG. 5 illustrates an example of the effect of special filtering on PAM-4 optical signal in accordance with certain aspects of the present disclosure.

To facilitate understanding, identical reference numerals have been used, where possible, to designate identical elements that are common to the figures. It is contemplated that elements disclosed in one embodiment may be beneficially utilized on other embodiments without specific recitation.

### DESCRIPTION OF EXAMPLE EMBODIMENTS

### Overview

Certain aspects of the present disclosure provide techniques for spatial filtering of pulse amplitude modulation (PAM) signals transmitted over multi-mode optical fiber cable links. The techniques described here may allow an increase in transmission bandwidth with limited additional cost (e.g., by using a single-mode fiber with an existing multi-mode fiber receiving front-end). The techniques generally include receiving a PAM optical signal (e.g., a network packet encode as a series of optical signal pulses) transmitted via an optical fiber, performing spatial filtering at a transition from the optical fiber to a receiver, and performing demodulation of the spatially filtered optical signal to decode the information of the network packet.

Certain aspects of the present disclosure provide an apparatus for spatial filtering of PAM signals transmitted over multi-mode optical fiber cable links. The apparatus generally includes a first interface for receiving the PAM signals from an optical fiber, a spatial filter for performing spatial filtering of the PAM signals, and a second interface for outputting the spatially filtered PAM signals for further processing.

Certain aspects of the present disclosure provide an apparatus for processing a network packet encoded as PAM signals transmitted over multi-mode optical fiber cable links. The apparatus generally includes a spatial filter for performing spatial filtering of the PAM signals, and at least one processor configured to demodulate the spatially filtered PAM signals and provide the demodulated signals to a receiver front end configured to decode the network packet.

### EXAMPLE EMBODIMENTS

Embodiments described herein provide techniques for spatial filtering of pulse amplitude modulated (PAM) signals, for example, used to encode information of a network packet as a series of optical signal pulses. In some cases, the spatial filtering may be performed at a transition from the optical fiber to a receiver. Demodulation may be performed on the spatially filtered optical signals to decode the information of the network packet.

A PAM signal is created by encoding data words into light pulses of different amplitude levels, and the encoded pulses can transmit multiple bits at the same time. In general, a PAM-N² technique is used to simultaneously transmit N bits of data. For example, a four-level Pulse Amplitude Modulation (PAM-4) scheme, or PAM-4 optical modulation technique, can be used to simultaneously transmit 2 bits of data. Optical PAM-4 has been considered as a standard for high-speed transmissions, such as 100 Gbit/s (100G) and 400 Gbit/s (400G) transmissions over optical fibers.

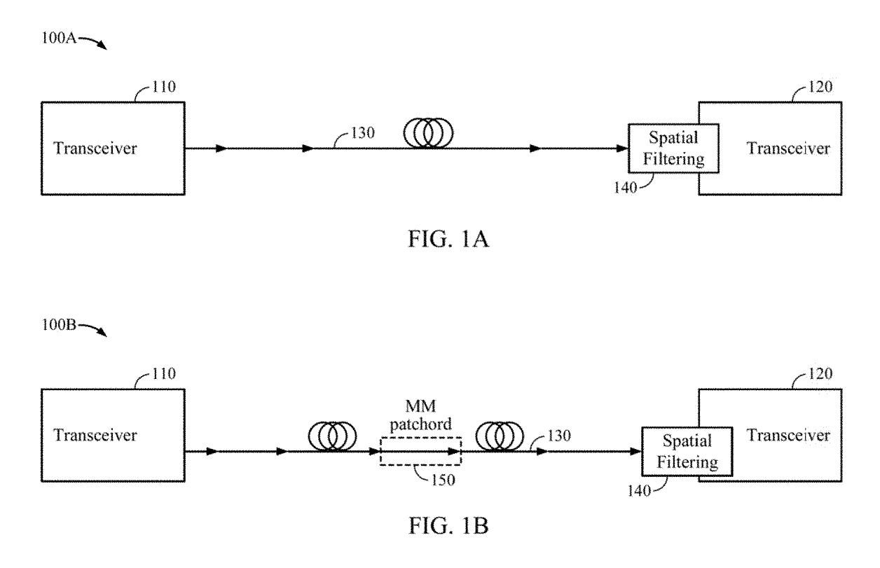

FIG. 1A illustrates an example of an optical network 100A, in which aspects of the present disclosure may be practiced. For example, transceivers 110 120 may be part of a network communication equipment or device (e.g., computers, servers, routers, etc.). In the illustrated example, a transceiver 110 is linked to another transceiver 120 via optical fiber cable 130. As illustrated, spatial filtering 140 of optical signals may be performed on the signals at a receiver interface of transceiver 120.

Techniques presented herein may be used to help improve performance of transceivers of a communication network (linked by multi-mode optical fiber cables 130 for chip-to-chip and/or server-to-server as shown in FIGS. 1A and 1B) that communicates using PAM. For example, as noted below, the spatial filtering described herein may help improve parameters of an eye diagram and, therefore, improve decoding performance and reduce bit error rate.

The techniques described herein may be used in any suitable type of optical network that utilizes PAM (e.g., to encode network packets). In some cases, the fiber link may be a 100-meter OM3 multi-mode fiber. FIG. 1B illustrates an example of an optical network 100B similar to that of FIG. 1A, but with a multi-mode patch fiber core linking two OM3 50-meter multi-mode fibers.

As described above, an optical fiber in cable 130 can guide light waves in distinct patterns called modes. Cable 130 can carry optical signals through one or more single-mode fibers (SMFs) and/or one or more multi-mode fibers (MMFs).

MMF is widely deployed in existing data transmission networks and systems. Transmission speeds (i.e., bandwidth or bit rate) through multi-mode fibers are typically limited by modal dispersion. In other words, different spatial modes supported by a multi-mode fiber propagate through the multi-mode fiber with different modal velocities, which lead to temporal spreading of an optical signal and limiting the speed at which data may be transmitted along the fiber. Such modal dispersion may be increased by deviations of the multi-mode fiber radial index profile from an ideal design index profile.

Index profile is the refractive index distribution across the core and the cladding of a fiber. Improvements in multi-mode fiber design and fabrication have resulted in fibers exhibiting reduced modal dispersion. However, there a need in further increasing the usable bandwidth of such improved multi-mode fiber, and in increasing the bandwidth of previously-deployed multi-mode fiber in legacy fiber-optic networks.

The principal difference between a single-mode fiber and a multi-mode fiber lies with physical dimensions in diameter lengths of their fiber core. A typical diameter may be about between 8 microns to 10 microns for single-mode fibers, and a typical diameter of multi-mode fibers can be about 50 microns or more.

Generally, the larger a diameter of a fiber core, the more modes the fiber can carry. As presented above, one problem with transmitting optical signals through a multi-mode fiber is intermodal dispersion. Intermodal dispersion is a phenomenon caused by different modes of light travelling at different speeds and/or different light paths along a multi-mode fiber. The different speeds and/or different light paths may not be arriving and received by a receiver at the same time, which causes distortions in optical signals transmitted through a multi-mode fiber.

Internal dispersion can be minimized through fiber design. One way is to vary the speed of each mode so that they can be received by a receiver at the same time. However, an optical signal can also be distorted by noise picked-up during signal transmission through a fiber. Optical signals transmitted through a multi-mode fiber pick up, or accumulate, more noise from the fiber than a single-mode fiber. One cause for this difference in noise accumulation during an optical signal transmission is that the fundamental mode of optical signals travels at approximate to center of a fiber core, where the noise from cladding of the fiber and from other external source is minimal. And the higher order modes spread away toward the cladding of the fiber.

A single-mode fiber can transmit an optical signal in fundamental mode, while a multi-mode fiber transmits an optical signal via multiple modes. As described above, the higher-order modes allow light waves to travel through a multi-mode fiber in different paths (bouncing off cladding of the fiber) and/or at different speeds, picking up and accumulate more noise than light waves that travel in the fundamental mode (approximate to center of a fiber core and no bouncing off of the cladding).

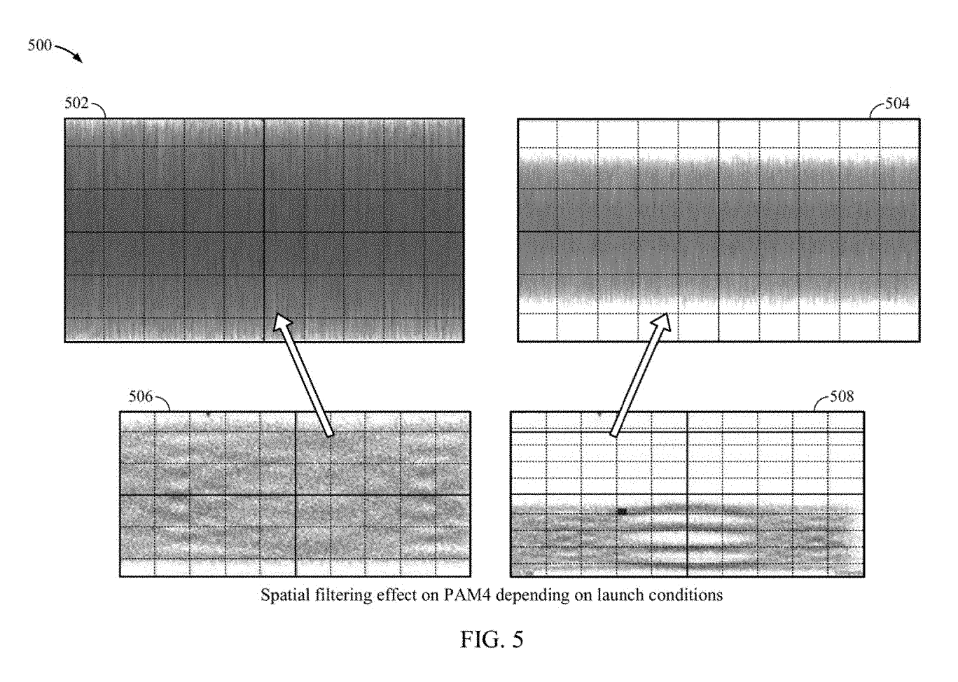

As will be described herein with reference to FIG. 5, this may result in noise and closing of an eye diagram of the PAM signal which may result in reduced processing performance, which may lead to increased bit error rates (BERs) Aspects of this disclosure take advantage of this fact by using spatial filtering to focus on fundamental mode (at the center of an optical fiber).

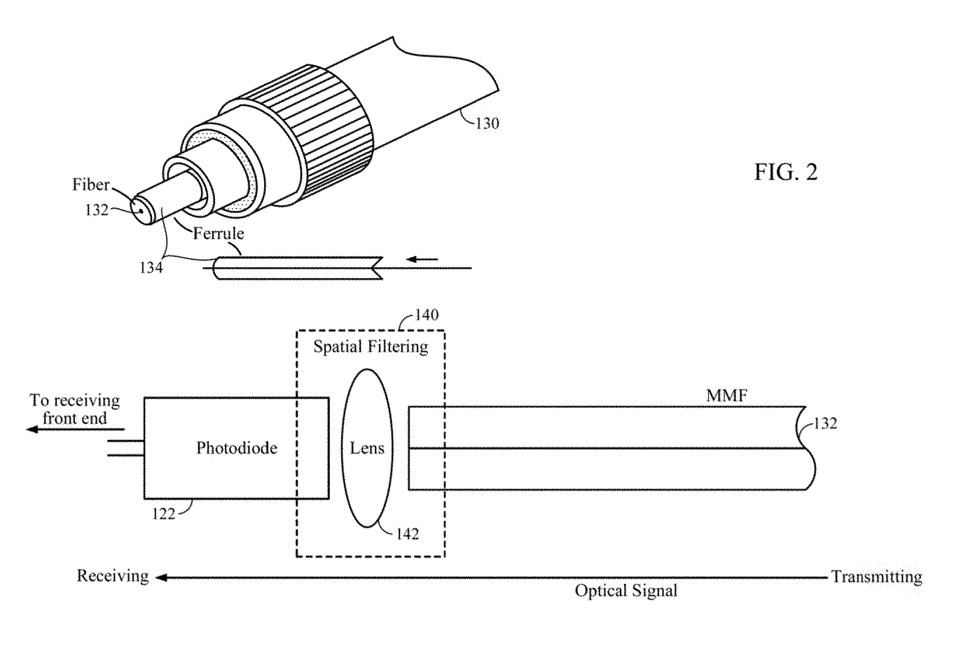

FIG. 2 illustrates an example of spatial filtering 140 of a PAM optical signal, in accordance with aspects of the present disclosure. As illustrated, the special filtering 140 can be achieved at the transition of the input receiver of the transceiver, such as at or within a ferrule 134 that couples the fiber 132 into the transceiver. In some embodiments, the spatial filtering 140 can be a part of a ferrule 134 (e.g., a spatial filter is contained, or located, within a ferrule that is used to couple an optical fiber to a receiver), a part of a transceiver, or as a standalone device. As noted below, the optical fiber cable 130 may contain single-mode fiber and/or multi-mode fiber.

The example shows a multi-mode fiber 132 of a cable 130 carrying an optical signal from transmitting side of a transceiver to receiving front-end of another transceiver, where spatial filtering 140 is by a focusing lens 142 and a photo-diode 122. A photo-diode 122 is a device that converts light into electrical signals, for example, to be provided to the receiver front end.

Photo-diodes may have small or large surface areas, and may contain built-in lenses. The example also shows that a ferrule 134 couples a fiber 132, where the fiber can be a single-mode or a multi-mode fiber. In some cases, a multi-mode fiber can be coupled and aligned to an active array area of a photo-diode 122 by a ferrule 134.

In one aspect of the present disclosure, spatial filtering of a PAM signal received from a multi-mode optical fiber can be achieved by aligning center of an optical fiber core carrying the PAM signal with an active array area of the photo-diode, where the photo-diode has an active array area smaller than the diameter of the multi-mode fiber. In one embodiment, diameter of a multi-mode optical fiber can be about 50 μm or larger, and a photo-diode can be about 16 μm in diameter. In some cases, a focusing lens 142 can be optimized to focus light on the photo-diode 122 for single-mode signal propagation. The higher-order modes of the multi-mode fiber outside of an illuminated area are automatically filtered because the illumination is only for the fundamental mode.

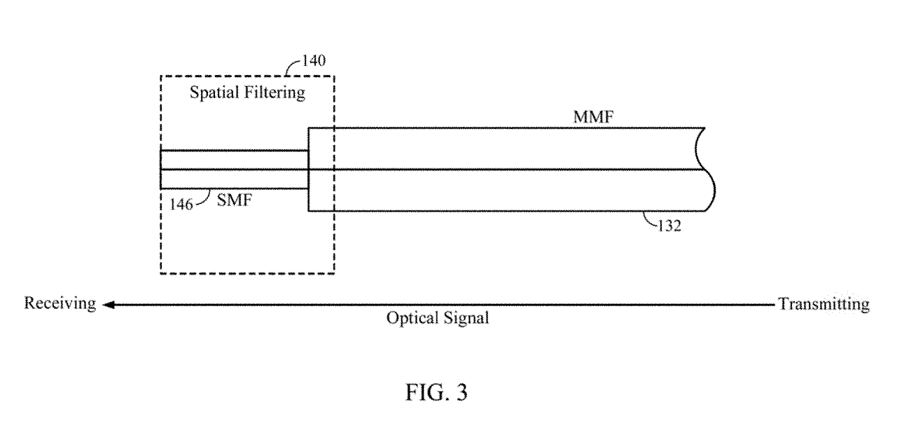

FIG. 3 illustrates another example of spatial filtering of a PAM optical signal, in accordance with aspects of the present disclosure. The example shows a multi-mode fiber 132 and spatial filtering 140 accomplished via a single-mode fiber (SMF) 146 between the multi-mode fiber 132 and receiving front-end of a transceiver. In some cases, the SMF 146 can be coupled and aligned by a ferrule 134 (e.g., coupling a multi-mode optical fiber 132 to a single-mode optical fiber 146 that has a smaller diameter than the multi-mode optical fiber). In one embodiment, a diameter of the SMF 146 may be about 9 μm, and a diameter of the multi-mode fiber 132 can be about 50 μm or more.

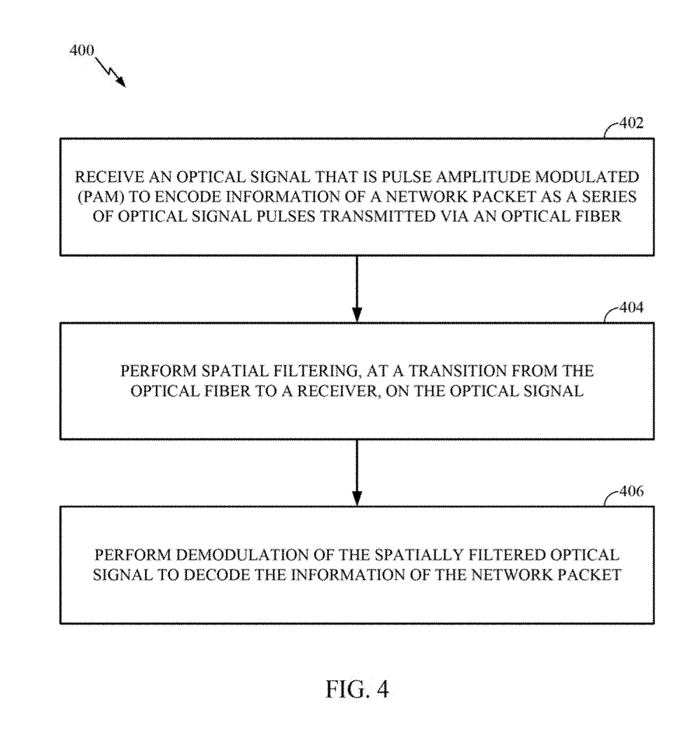

FIG. 4 illustrates example operations 400 for spatial filtering at a transition of PAM optical signals received at a transceiver from a multi-mode fiber. The operations shown in FIG. 4, for example, may represent more specific examples of the operations described above. The operations 400 may be performed by any suitable components (e.g., using any suitable optical spatial filter) and a processor of an optical receiver front end.

The operations 400 begins, at 402, by receiving an optical signal that is pulse amplitude modulated (PAM) to encode information of a network packet as a series of optical signal pulses transmitted via an optical fiber. At 404, spatial filtering is performed at a transition from the optical fiber to a receiver, on the optical signal. As described herein, the spatial filtering is performed at a transition from the optical fiber to a receiver (e.g., in a ferrule used to couple the optical fiber to the receiver). At 406, the transceiver performs demodulation of the spatially filtered optical signal to decode the information of the network packet.

FIG. 5 illustrates the effect of spatial filtering on PAM optical signals, according to aspects of the present disclosure. The example shows a PAM-4 optical signal waveform before and after spatial filtering, and the impact on signal processing (e.g., improving the eye diagram and overall decoding performance).

Waveform 502 is a graphical representation of the optical signal waveform before spatial filtering, and 506 shows an eye diagram corresponding to the signal waveform represented in 502. An eye diagram or eye pattern can be an insightful graphical representation of optical and electrical communication signals. An eye diagram can be obtained by overlaying or folding each bit of a signal data waveform onto a fixed bit period, or an eye bit period. Over a sampling time period, the overlaid data bits form into a graphical shape that resembles an eye-opening. Signal quality of the waveform can be discerned from the appearance of its eye diagram or eye pattern.

Generally, an eye diagram of a signal waveform with two discrete amplitude levels should have one eye-opening. Depending on the number of discrete amplitude levels, an eye diagram may contain multiple eye-openings. For example, by overlaying (e.g., several thousands or even millions of) bits of a PAM-4 (four discrete signal amplitude levels) optical signal waveform over an eye bit period, an eye diagram corresponding to the PAM-4 data signals should have three eye-openings. In theory, an ideal signal waveform produces an ideal eye diagram, with instantaneous rising and falling edges. Practically, however, because of time-delays and noise in a data signal waveform (e.g., optical signals transmitted over multi-mode fibers pick up noise from cladding of the fibers, as described above), an eye diagram can become less distinct (e.g., eye-closure, where an eye-height is less than eye-amplitude). This is because the time-delays and noise are overlaid onto the eye bit period along with the signals. In general, a high amount of eye-closure correlates to a high level of noise in a signal waveform, and a distinct eye-opening correlates to a low noise level in a signal waveform.

Waveform 502 generally illustrates a graphical representation of data signals transmitted over a multi-mode fiber without spatial filtering. 506 shows an eye diagram corresponding to 502, which is a graphical representation of statistical average (repeatedly overlaying) of many samples (e.g., thousands or millions) taken from, at least in part, the signal waveform in 502. As illustrated, the eye diagram from 506 indicates signal quality of the PAM-4 signals is less than ideal, due to noise described above.

Waveform 504 shows a graphical representation of data signals transmitted over a multi-mode fiber after spatial filtering. Eye diagram 508 shows an eye diagram corresponding to the waveform in 504. In general, eye diagram 508 shows improved signal quality of the PAM-4 signals represented in 504, relative to before spatial filtering (which is illustrated in waveform signals 502 and eye diagram 506).

As mentioned above, an eye height is a measure of the vertical opening of an eye diagram, and an ideal eye height should equal to the eye-amplitude. Noise in the signals can be captured and appear in an eye diagram as eye-closure (e.g., 506). A high amount of eye-closure correlates to a high noise level in the sampled data signals. 506 shows a higher amount of eye-closure without spatial filtering than 508, which shows a smaller amount of eye-closure. The eye diagram of 508 is clearer (less eye-closure) due to a lower noise level in the sampled data signals after the signals have been spatially filtered, which may lead to improved decoding performance.

In addition, the example of FIG. 5 also illustrates a reduction of waveform amplitude in 504 relative to the waveform amplitude in 502. The cause for this amplitude reduction may be that both noise and signals in the higher order modes of the multi-mode fiber were spatially filtered. Thus, an overall power level of the signal waveform may be reduced by the spatial filtering. The example also shows a corresponding reduction in amplitude of the eye diagram 508 relative to the eye diagram 506. The eye diagram amplitude reduction was also due to the spatial filtering of the higher order modes. In certain aspects of the present disclosure, the power variation, or penalty, may be compensated with an Automatic Gain Control (AGC) at an amplifier of the receiving front-end.

As mentioned above, a PAM signal traveling through a fiber, especially a multi-mode fiber, picks up noise, which distorts the PAM signal and causes a partially or completely closed eye diagram of the signal. In some cases, spatial filtering described herein may be combined with processing techniques, such as a feed forward equalizer (FFE) at a receiver to re-open the eye diagram by making correction to voltage levels at locations of interest on a signal waveform. In general, FFE uses voltage levels of a received waveform associated with previous and current bits to correct the voltage level of the current bit. A FFE algorithm may utilize taps in making corrections to the received voltage levels.

Traditionally, a very strong equalizer at a receiver can be used to compensate signal power loss for all modes of a multi-mode fiber. One of many disadvantages of this traditional approach is that the approach increases complexity and drives up cost of a signal processing system.

In certain aspects of the present disclosure, without changing transmitter launch power, spatial filtering on a received PAM signal only causes small variations in equalizer taps settings. Therefore, with the spatial filtering, the equalizer taps settings can remain static, or fixed, and a fast Automatic Gain Control (AGC) can be used to compensate the voltage level variations before the received PAM signal propagates to the equalizer (e.g., adjusting one or more automatic gain control (AGC) parameters at the receiver to compensate for power loss in the PAM optical signal caused by the spatial filtering). In some cases, a processor may be configured to adjust one or more automatic gain control (AGC) parameters at the receiver to compensate for power loss in the PAM optical signal caused by the spatial filtering.

In certain aspects of the present disclosure, a change of power due to spatial filtering and/or a change in launch conditions can be compensated by a fast Automatic Gain Control (AGC) in a receiver, so that a constant voltage swing may result. In some case, the AGC does not need to be fast, a normal AGC that is available at a linear transimpedance amplifier (TIA) can be sufficient to compensate for dynamic variations caused by a spatial filtering. In some cases, an apparatus may include circuitry to measure amplitude of the PAM optical signal (e.g., a circuit for measuring an amplitude of a PAM optical signal before and/or after spatial filtering, and the AGC may be adjusted based on the amplitude measurements).

The spatial filtering techniques described herein may be performed on any type of PAM optical signals. For example, as described herein the techniques may be applied to PAM-4 optical signals transmitted over higher order multi-mode fibers.

The spatial filtering techniques may be applied to a variety of fiber cables and allow the use of conventional receiver front ends. For example, the spatial filtering may be applied to PAM signals conveyed over optical fibers, such as, OM3 (50 um, Modal Bandwidth (MBW) of 2000 MHz/km), OM4 (50 um, MBW of 4700 MHz/km), or other higher order multi-mode fibers 132 that are suitable for a communication network.

As a result, the spatial filtering techniques described herein may allow for flexible network design, for example, by allowing the use of MMF with SMF front-ends (e.g., compatibility with existing MMF plant). This may result in increased decoding performance and significant reductions in bit error rates at relatively low additional cost.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or combinations thereof.

Those of skill would further appreciate that the various illustrative logical blocks, modules, circuits, and algorithm steps described in connection with the disclosure herein may be implemented as electronic hardware, software/firmware, or combinations thereof. To clearly illustrate this interchangeability of hardware and software/firmware, various illustrative components, blocks, modules, circuits, and steps have been described above generally in terms of their functionality. Whether such functionality is implemented as hardware or software/firmware depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software/firmware module executed by a processor, or in a combination thereof. A software/firmware module may reside in RAM memory, flash memory, ROM memory, EPROM memory, EEPROM memory, phase change memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software/firmware, or combinations thereof. If implemented in software/firmware, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD/DVD or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software/firmware is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

We claim:

1. A method comprising:
receiving a pulse amplitude modulated (PAM) optical signal used to encode information of a network packet as a series of optical signal pulses transmitted via an optical fiber;
performing spatial filtering of the PAM optical signal; and
performing demodulation of the spatially filtered optical signal to decode the information of the network packet.

2. The method of claim 1, wherein the spatial filtering is performed at a transition from the optical fiber to a receiver.

3. The method of claim 2, wherein the spatial filtering is performed within a ferrule used to couple the optical fiber to the receiver.

4. The method of claim 1, wherein the PAM optical signal is pulse amplitude modulated according to at least a four-level pulse amplitude modulation (PAM-4) scheme.

5. The method of claim 1, wherein:
the spatial filtering is performed by focusing light from the PAM optical signal onto a photo-diode array that has a smaller diameter than the optical fiber.

6. The method of claim 1, wherein:
the optical fiber comprises a multi-mode optical fiber; and
the spatial filtering is performed by coupling the multi-mode optical fiber to a single-mode optical fiber that has a smaller diameter than the multi-mode optical fiber.

7. The method of claim 1, further comprising adjusting one or more automatic gain control (AGC) parameters at the receiver to compensate for power loss in the PAM optical signal caused by the spatial filtering.

8. An apparatus, comprising:
a first interface for receiving a pulse amplitude modulated (PAM) optical signal;
a spatial filter configured to perform spatial filtering of the PAM signal; and
a second interface for outputting the spatially filtered PAM optical signal to a receiver for further processing.

9. The apparatus of claim 8, wherein the spatial filter is contained within a ferrule used to couple the optical fiber to the receiver.

10. The apparatus of claim 8, wherein the PAM optical signal is pulse amplitude modulated according to at least a four-level pulse amplitude modulation (PAM-4) scheme.

11. The apparatus of claim 8, wherein:
the spatial filter comprises a lens for focusing light from the PAM optical signal onto a photo-diode array that has a smaller diameter than the optical fiber.

12. The apparatus of claim 8, wherein:
the optical fiber comprises a multi-mode optical fiber; and
the spatial filter comprises a single-mode optical fiber that has a smaller diameter than the multi-mode optical fiber.

13. An apparatus for processing a network packet encoded as a pulse amplitude modulated (PAM) optical signal, comprising:
a spatial filter configured to perform spatial filtering of the PAM signal; and
at least one processor configured to demodulate the spatially filtered PAM signal and provide demodulated signals to a receiver configured to decode the network packet.

14. The apparatus of claim 13, wherein the spatial filter is located at a transition from the optical fiber to the receiver.

15. The apparatus of claim 14, wherein the spatial filter is located within a ferrule used to couple the optical fiber to the receiver.

16. The apparatus of claim 13, wherein the PAM optical signal is pulse amplitude modulated according to at least a four-level pulse amplitude modulation (PAM-4) scheme.

17. The apparatus of claim 13, wherein:
the spatial filter comprises a lens configured to focus light from the PAM optical signal onto a photo-diode array that has a smaller diameter than the optical fiber.

18. The apparatus of claim 13, wherein:
the optical fiber comprises a multi-mode optical fiber; and
the spatial filter comprises a single-mode optical fiber that has a smaller diameter than the multi-mode optical fiber.

19. The apparatus of claim 13, wherein the at least one processor is further configured to adjust one or more automatic gain control (AGC) parameters at the receiver to compensate for power loss in the PAM optical signal caused by the spatial filtering.

20. The apparatus of claim 19, further comprising a circuit for measuring an amplitude of the PAM optical signal, wherein the AGC is adjusted based on the amplitude measurements.
